(19) United States
(12) Patent Application Publication
(10) Pub. No.: US 2021/0241103 A1
(43) Pub. Date: Aug. 5, 2021

(54) ADAPTIVE LEARNING DEVICE OF DATA POSITIONAL RELATIONSHIP, ADAPTIVE LEARNING METHOD OF DATA POSITIONAL RELATIONSHIP, AND RECORDING MEDIUM STORING ADAPTIVE LEARNING PROGRAM OF DATA POSITIONAL RELATIONSHIP

(71) Applicant: NEC Corporation, Tokyo (JP)

(72) Inventor: Takashi MARUYAMA, Tokyo (JP)

(73) Assignee: NEC Corporation, Tokyo (JP)

(21) Appl. No.: 17/152,207

(22) Filed: Jan. 19, 2021

(30) Foreign Application Priority Data
Jan. 30, 2020 (JP) 2020-013916

(51) Int. Cl. G06N 3/08; G06N 3/04

(52) U.S. Cl. CPC G06N 3/08; G06N 3/04

(57) ABSTRACT

An adaptive learning device of data positional relationship includes: an arithmetic unit that calculates a parameter of a model having a mapping function of plotting a plurality of pieces of data in a Euclidean space, the parameter minimizing a triplet loss function to which a value of the model is input when a triplet set is given to the model; a determination unit that determines whether a group made up of the model having the parameter being calculated and the triplet set satisfies a predetermined conditional expression; and a first generation unit that generates a new triplet set to be targeted for an arithmetic operation by the arithmetic unit, by removing at least one triplet from the triplet set of the group determined not to satisfy the predetermined conditional expression, thereby enabling learning of the positional relationship between the pieces of data when any data set is given.

This application is based upon and claims the benefit of priority from Japanese Patent Application No. 2020-013916, filed on Jan. 30, 2020, the disclosure of which is incorporated herein in its entirety by reference.

### TECHNICAL FIELD

The present invention relates to an adaptive learning device of data positional relationship, an adaptive data learning method of data positional relationship, and an adaptive learning program of data positional relationship that perform distance learning, which is one field of machine learning. In particular, the present invention relates to an adaptive learning device of data positional relationship, an adaptive learning method of data positional relationship, and an adaptive learning program of data positional relationship that generate learning data required for distance learning on the basis of a given data set and learn positional relationships between pieces of data. In the following disclosure of the present application, it is assumed that the term “data” is also understood as a data set and a data record.

### BACKGROUND ART

The purpose of learning in distance learning, which is one field of machine learning, is to learn positional relationships between pieces of data in which any numerical data is employed as a reference and any piece of data is supposed to go farther from or come closer to the set reference. Specifically, the purpose of learning is to learn a rule for converting data into a continuous space that enables positional relationships between pieces of data in which any piece of data goes farther from or comes closer to the reference.

For example, a triplet loss function is used as a function for measuring the degree of progress of learning the positional relationships between pieces of data. A triplet is a data group made up of three pieces of data: anchor data xₐ as a reference; positive data xₚ desired to be made closer to the anchor data xₐ; and negative data xₙ desired to be made far from the anchor data xₐ.

Hereinafter, a group made up of three elements belonging to a given data set is referred to as a triplet and written as (xₐ, xₚ, xₙ). A set including only a triplet as an element is referred to as a triplet set.

The triplet loss function is a function for measuring each positional relationship between pieces of data when the triplet (xₐ, xₚ, xₙ) is plotted in a continuous space. That is, the triplet loss function individually measures a positional relationship between the anchor data xₐ and the positive data xₚ, and a positional relationship between the anchor data xₐ and the negative data xₙ.

In distance learning using the triplet loss function, the triplet loss function is minimized to learn the positional relationship between pieces of data. For example, PTL 1 (JP 2019-083002 A) describes a font recognition system using a triplet loss model.

NPL 1 (F. Schroff, D. Kalenichenko, and J. Philbin, “Facenet: A unified embedding for face recognition and clustering”, In Proceedings of the IEEE conference on computer vision and pattern recognition, pages 815-823, 2015) describes a system called FaceNet that directly learns mapping to a compact Euclidean space on the basis of a face image.

The FaceNet described in “Facenet: A unified embedding for face recognition and clustering” learns a conversion rule for image data by minimizing the triplet loss function on the basis of an image data set whose element is image data assigned with the identifier.

In the FaceNet described in “Facenet: A unified embedding for face recognition and clustering”, a group made up of three pieces of image data is used when the conversion rule for the image data is learned. The group described in “Facenet: A unified embedding for face recognition and clustering”, in which image data handled by the FaceNet is used as an element, is an example of a triplet.

The specific configuration method for the triplet set used by the FaceNet to learn the conversion rule described in “Facenet: A unified embedding for face recognition and clustering” is made up of, for example, steps 1 to 3 indicated below.

(Step 1) For each identifier assigned to the image data, six pieces of image data to which the same identifier is assigned are selected as anchor data.

(Step 2) For each identifier assigned to the image data, five pieces of image data to which the same identifier is assigned are selected as positive data. The selected five pieces of image data and the six pieces of image data selected in step 1 are then combined to generate 30 groups made up of the anchor data and the positive data per one identifier.

(Step 3) For each group made up of the anchor data and the positive data generated in step 2, one piece of image data to which an identifier different from the identifier of the anchor data and the positive data is assigned is selected. A triplet made up of the anchor data, the positive data and the negative data is then generated by combining the selected image data and the group made up of the anchor data and the positive data.

### SUMMARY

An object of the present invention is to provide an adaptive learning device of data positional relationship, an adaptive learning method of data positional relationship, and an adaptive learning program of data positional relationship capable of learning positional relationships between pieces of data even when any data set is given.

In an example embodiment of the present invention, an adaptive learning device of data positional relationship includes: an arithmetic unit that calculates a parameter of a model having a mapping function of plotting a plurality of pieces of data in a Euclidean space, the parameter minimizing a triplet loss function to which a value of the model is input when a triplet set is given to the model; a determination unit that determines whether a group made up of the model having the parameter being calculated and the triplet set satisfies a predetermined conditional expression; and a first generation unit that generates a new triplet set to be targeted for an arithmetic operation by the arithmetic unit, by removing at least one triplet from the triplet set of the group determined not to satisfy the predetermined conditional expression.

In an example embodiment of the present invention, an adaptive learning method of data positional relationship includes: calculating a parameter of a model having a mapping function of plotting a plurality of pieces of data in a Euclidean space, the parameter minimizing a triplet loss function to which a value of the model is input when a triplet set is given to the model; determining whether a group made up of the model having the parameter being calculated and the triplet set satisfies a predetermined conditional expression; and generating a new triplet set to be targeted for an arithmetic operation, by removing at least one triplet from the triplet set of the group determined not to satisfy the predetermined conditional expression.

In an example embodiment of the present invention, an adaptive learning program of data positional relationship causes a computer to execute: an arithmetic process of calculating a parameter of a model having a mapping function of plotting a plurality of pieces of data in a Euclidean space, the parameter minimizing a triplet loss function to which a value of the model is input when a triplet set is given to the model; a determination process of determining whether a group made up of the model having the parameter being calculated and the triplet set satisfies a predetermined conditional expression; and a generation process of generating a new triplet set to be targeted for the arithmetic process, by removing at least one triplet from the triplet set of the group determined not to satisfy the predetermined conditional expression.

### BRIEF DESCRIPTION OF THE DRAWINGS

FIG. 1 is a block diagram illustrating a configuration example of an adaptive learning device of data positional relationship according to an example embodiment of the present invention;

FIG. 2 is an explanatory diagram illustrating a process in which a triplet set generation unit generates a triplet set on the basis of a data set with identifiers;

FIG. 3 is an explanatory diagram illustrating a process in which a triplet set reduction unit removes a subset from the triplet set;

FIG. 4 is a flowchart illustrating working of a learning process of data positional relationship performed by the adaptive data positional relationship learning device according to the present example embodiment;

FIG. 5 is an explanatory diagram illustrating a specific example of the learning process of data positional relationship;

FIG. 6 is an explanatory diagram illustrating a graph targeted by the learning process of data positional relationship according to the present example embodiment;

FIG. 7 is an explanatory diagram illustrating the execution results of the learning process of data positional relationship according to the present example;

FIG. 8 is a schematic block diagram illustrating a configuration example of a computer on which the adaptive learning device of data positional relationship of the present example embodiment is mounted; and

FIG. 9 is a block diagram illustrating an outline of the adaptive learning device of data positional relationship according to the present invention.

### EXAMPLE EMBODIMENT

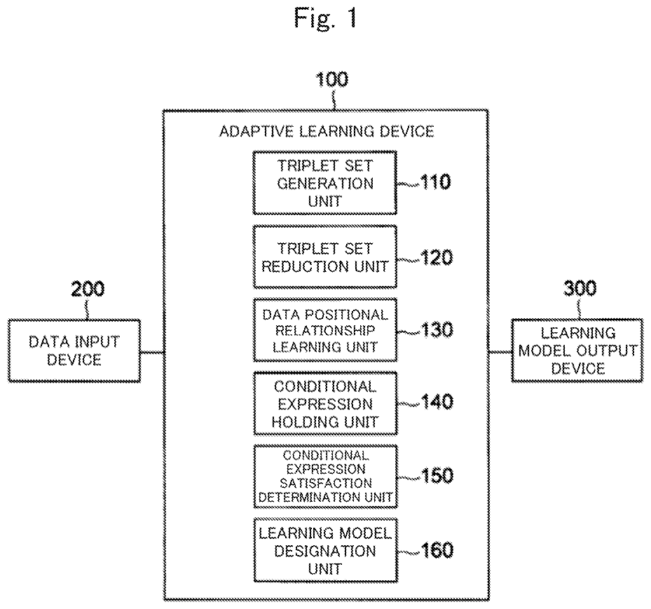

Example embodiments of the present invention will be described below with reference to the drawings. FIG. 1 is a block diagram illustrating a configuration example of an adaptive learning device of data positional relationship according to an example embodiment of the present invention.

The adaptive learning device 100 of data positional relationship according to the present example embodiment is characterized in that a triplet set used for distance learning is derived in a searching manner by repeatedly executing a process of decreasing elements of the triplet set and a process of learning the triplet set.

The adaptive learning device 100 of the present example embodiment illustrated in FIG. 1 includes a triplet set generation unit 110, a triplet set reduction unit 120, a data positional relationship learning unit 130, a conditional expression holding unit 140, a conditional expression satisfaction determination unit 150, and a learning model designation unit 160.

As illustrated in FIG. 1, a data input device 200 is connected to the adaptive learning device 100 in such a way that communication is enabled. A learning model output device 300 is connected to the adaptive learning device 100 in such a way that communication is enabled.

The triplet set generation unit 110 has a function of receiving a data set with identifiers as an input and generating a triplet set on the basis of the received data set. The triplet set generation unit 110 generates a triplet set on the basis of a data set with identifiers given from the data input device 200.

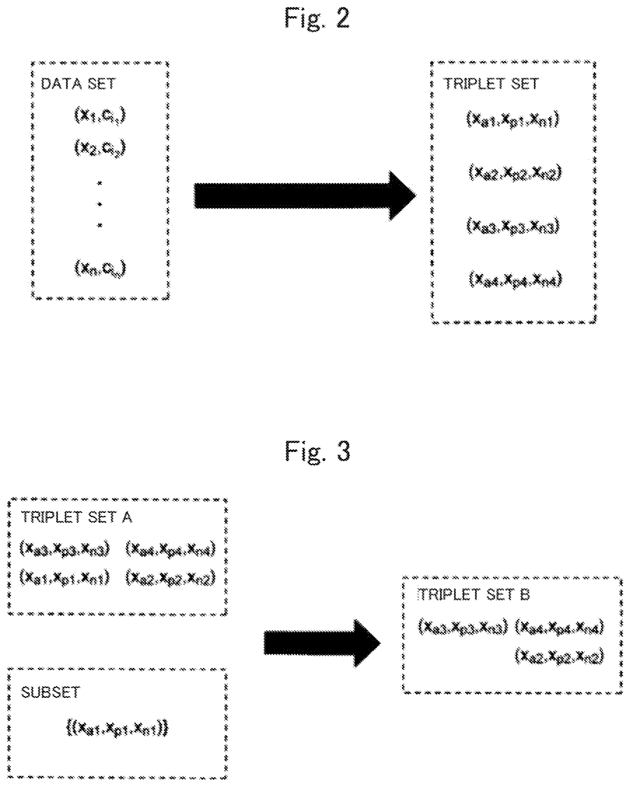

FIG. 2 is an explanatory diagram illustrating a process in which the triplet set generation unit 110 generates a triplet set on the basis of a data set with identifiers.

The data set illustrated in FIG. 2 is a data set with identifiers input from the data input device 200. Each element of the data set illustrated in FIG. 2 is made up of data xⱼ and an identifier cᵢⱼ of the data. An example of the group of the data xⱼ and the identifier cᵢⱼ of the data is a group of image data and an image data name.

The group of the data xⱼ and the identifier cᵢⱼ of the data constituting the data set is not limited to the group of the image data and the image data name. For example, a group of an attribute of the vertex of a graph and a category of the attribute, which is a typical data structure used when a social graph or the like is represented, may be employed as the group of the data xⱼ and the identifier cᵢⱼ of the data.

The triplet set illustrated in FIG. 2 is a set of triplets made up of the data xⱼ constituting an element of the input data set with identifiers. With respect to the triplet (xₐⱼ, xₚⱼ, xₙⱼ) illustrated in FIG. 2, anchor data xₐⱼ and positive data xₚⱼ constituting the triplet are elements to which the same identifier is assigned.

Negative data xₙⱼ constituting the triplet is an element to which an identifier different from the identifier of the anchor data xₐⱼ and the positive data xₚⱼ is assigned. In the example illustrated in FIG. 2, the triplet set generation unit 110 randomly generates four triplets and outputs a triplet set made up of the generated triplets.

The triplet set generation process executed by the triplet set generation unit 110 may be a process other than the process illustrated in FIG. 2 in which four triplets are randomly sampled (extracted as samples). The triplet set generation process may be any process as long as the process generates a triplet set including a triplet made up of data constituting an input data set with identifiers.

For example, the triplet set generation process may be a process of generating a triplet set made up of all possible triplet combinations of a plurality of pieces of data constituting a data set with identifiers. That is, the triplet set generation unit 110 may generate all triplets that are generatable, on the basis of the data set with identifiers, and generate the triplet set made up of all the generated triplets.

As described above, the triplet set generation unit 110 generates a triplet set targeted for the arithmetic operation by the data positional relationship learning unit 130, on the basis of a data set made up of a plurality of pieces of data, to each of which an identifier is assigned, where a positional relationship between the plurality of pieces of data of the data set are targeted for learning.

The triplet set reduction unit 120 has a function of removing, from a given triplet set, a subset of the triplet set that is not an empty set.

The triplet set reduction unit 120 receives a triplet set and subsets of the triplet set as inputs, and removes an input subset (but not an empty set) from the input triplet set. Subsequently, the triplet set reduction unit 120 outputs a newly obtained triplet set.

FIG. 3 is an explanatory diagram illustrating a process in which the triplet set reduction unit 120 removes a subset from the triplet set. A triplet set A illustrated in FIG. 3 is a triplet set whose part is to be removed by the triplet set reduction unit 120. A subset illustrated in FIG. 3 is a subset of the triplet set A.

The triplet set reduction unit 120 receives the triplet set A and the subset of the triplet set A as inputs. The triplet set reduction unit 120 then removes the subset from the triplet set A.

A triplet set B illustrated in FIG. 3 is a triplet set newly obtained by the triplet set reduction unit 120 removing the subset. The triplet set reduction unit 120 finally outputs the triplet set B.

The subset of the triplet set input to the triplet set reduction unit 120 may be a subset made up of a plurality of elements, instead of the subset illustrated in FIG. 3, which is made up of a single element.

The data positional relationship learning unit 130 has a function of calculating a parameter of a model supposed to minimize the triplet loss function with respect to given triplet set and model. For example, the data positional relationship learning unit 130 receives a set including one or more triplet sets as elements as an input, and generates a model for each element (triplet set) of the input set.

The data positional relationship learning unit 130 then inputs a triplet belonging to the triplet set to the generated model, and computes the triplet loss function using the value of the model when the triplet is input. The data positional relationship learning unit 130 performs the process of computing the triplet loss function for each triplet belonging to the triplet set.

Subsequently, the data positional relationship learning unit 130 calculates a parameter of the model supposed to minimize the total sum of the individually computed triplet loss functions. The data positional relationship learning unit 130 performs the process of calculating the parameter of the model for each triplet set belonging to the input set.

A model f_{θ} (θ denotes a parameter of the model f) handled by the data positional relationship learning unit 130 may be any model as long as the model has a mapping function of plotting a plurality of pieces of data in the Euclidean space. For example, the model f_{θ} may be a neural network model or a graph neural network model.

The model f_{θ} handled by the data positional relationship learning unit 130 may be given manually or by an arithmetic operator (not illustrated) that derives the model f_{θ}.

The triplet loss function used by the data positional relationship learning unit 130 is defined by, for example, the following expression.

[Mathematical Expression 1]

Lₜᵣᵢₚₗₑₜ(xₐ,xₚ,xₙ)=max(dₚ(ƒ_{θ}(xₐ),ƒ_{θ}(xₚ))−dₙ(ƒ_{θ}(xₐ),ƒ_{θ}(xₙ))+α,0) Expression (1)

Expression (1) represents a triplet loss function when a triplet (xₐ, xₚ, xₙ) is used as an input. The sign f_{θ} appearing on the right side of expression (1) represents a model having a parameter. The signs dₚ and dₙ appearing on the right side of expression (1) both represent distance functions for the Euclidean space, and are defined as follows.

dₚ,dₙ: [symbol] ⁿ× [symbol] ⁿ→ [symbol] _{≥0} [Mathematical Expression 2]

The sign α appearing on the right side of expression (1) represents a non-negative real number. The term max (x, y, . . . ) appearing on the right side of expression (1) represents a function that returns the largest element of the set {x, y, . . . }.

The total sum of the triplet loss functions to which the triplets included in the triplet set have been input across all the triplets included in the triplet set is defined by, for example, the following expression.

$$\begin{matrix}[ Mathematical Expression 3 ] & \\ {L}_{total} = {\sum }_{( {x}_{a} , {x}_{p} , {x}_{n} )} {L}_{triplet} ( {x}_{a} , {x}_{p} , {x}_{n} ) & Expression ( 2 )\end{matrix}$$

The data positional relationship learning unit 130 calculates the total sum of the triplet loss functions across all the input triplets in accordance with, for example, expression (2). The data positional relationship learning unit 130 then calculates the parameter θ of the model f_{θ} supposed to minimize the calculated total sum for each triplet set.

That is, the data positional relationship learning unit 130 calculates the parameter θ of the model f_{θ} for each element (triplet set) of the input set. Finally, the data positional relationship learning unit 130 outputs a set of the models f_{θ} having the calculated parameters θ.

The algorithm used when calculating the parameter θ supposed to minimize the total sum of the triplet loss functions may be any algorithm as long as the algorithm is supposed to minimize the total sum. For example, the algorithm may be a steepest descent method, a stochastic gradient descent method, a greedy method, or a local search method.

As described above, the data positional relationship learning unit 130 calculates a parameter of a model having the mapping function of plotting a plurality of pieces of data in the Euclidean space, in which the parameter minimizes the triplet loss function to which a value of the model when a triplet set is given to the model is input.

The conditional expression holding unit 140 has a function of holding conditional expressions that are likely to be referred to by the conditional expression satisfaction determination unit 150. The conditional expression holding unit 140 is a component for holding a conditional expression having, as arguments, a triplet set and a function having the triplet set as an input, for example. The conditional expression held in the conditional expression holding unit 140 is, for example, the following expression.

[Mathematical Expression 4]

R(X,ƒ)=Iƒ{ƒ(X)<t} Expression (3)

Expression (3) is an expression that defines a condition concerning a triplet set X and a function f having the triplet set X as an input. The function f corresponds to the model f_{θ} having the parameter θ output from the data positional relationship learning unit 130.

The right side of expression (3) is a mathematical expression that compares a value f(X) when the triplet set X is input to the function f with a threshold value t. Finally, expression (3) is an expression that returns a truth value (True or False) that means that the value f(X) is truly smaller than the threshold value t, or truly equal to or more than the threshold value t.

The mathematical expression on the right side of the conditional expression may be a mathematical expression other than the mathematical expression that compares the value f(X) when the triplet set X is input to the function f with the threshold value t. The threshold value t may be manually given in advance.

For example, the mathematical expression on the right side of the conditional expression may be a mathematical expression that determines whether “the time taken from the input of the triplet set X to the function f to the derivation of the value is less than a predetermined time”. Alternatively, the mathematical expression on the right side of the conditional expression may be a mathematical expression that determines whether “the number of elements of the triplet set X is equal to or more than the positive square root of the complexity of the function f as a model”.

The mathematical expression on the right side of the conditional expression may not include both of the triplet set X and the function f as arguments. That is, in the mathematical expression on the right side of the conditional expression, only the triplet set X may be included as an argument, or only the function f may be included as an argument.

For example, the mathematical expression on the right side of the conditional expression may be a mathematical expression that determines whether “the number of elements of the triplet set X is equal to or more than the threshold value t”. Alternatively, the mathematical expression on the right side of the conditional expression may be a mathematical expression that determines whether “the complexity of the function f as a model is equal to or more than a threshold value s”.

The conditional expression holding unit 140 may hold not only one conditional expression but also a plurality of conditional expressions.

The conditional expression satisfaction determination unit 150 has a function of determining whether a value calculated by inputting a triplet set to a model having the calculated parameter satisfies a conditional expression specified in advance.

For example, the conditional expression satisfaction determination unit 150 selects one or two or more conditional expressions from among the conditional expressions held in the conditional expression holding unit 140. When two or more conditional expressions are selected, for example, the conditional expression satisfaction determination unit 150 generates a new conditional expression by coupling the selected two or more conditional expressions with a logical operator.

For example, when conditional expressions R₁(X, f), R₂(X, f), . . . , and Rₙ(X, f) (n is an integer equal to or more than two) are selected from the conditional expression holding unit 140, the conditional expression satisfaction determination unit 150 couples the selected conditional expressions by a logical operator as follows.

[Mathematical Expression 5]

R₁(X,ƒ)∧R₂(X,ƒ)∧ . . . ∧Rₙ(X,ƒ) Expression (4)

The conditional expression satisfaction determination unit 150 generates conditional expression (4) by applying a logical operator in accordance with a procedure specified in advance. The sign \hat{ } appearing in conditional expression (4) represents the logical AND.

The conditional expression satisfaction determination unit 150 may use not only the logical AND but also the logical OR and negation as logical operators when coupling conditional expressions. The procedure of the coupling process performed by the conditional expression satisfaction determination unit 150 may be prescribed manually or mechanically.

The conditional expression satisfaction determination unit 150 then determines whether the triplet set X and the function f satisfy the one selected conditional expression or the newly generated conditional expression. The conditional expression satisfaction determination unit 150 may not perform the coupling process as described above even when two or more conditional expressions are selected.

As described above, the conditional expression satisfaction determination unit 150 determines whether a group made up of a model having the calculated parameter and a triplet set satisfies a predetermined conditional expression. The triplet set reduction unit 120 generates a new triplet set to be targeted for an arithmetic operation by the data positional relationship learning unit 130, by removing at least one triplet (subset) from the triplet set of a group determined not to satisfy the predetermined conditional expression.

The learning model designation unit 160 receives a triplet set and a model that satisfy the conditional expression, as inputs from the conditional expression satisfaction determination unit 150. The learning model designation unit 160 has a function of calculating a parameter of a model supposed to minimize the triplet loss function with respect to given triplet set and model.

The learning model designation unit 160 calculates a parameter of the input model supposed to minimize the triplet loss function to which the input triplet set has been given. The learning model designation unit 160 may calculate a parameter of the model using a method similar to, for example, a method by which the data positional relationship learning unit 130 calculates a parameter of the model.

The learning model designation unit 160 then inputs the model having the calculated parameter as a learning model to the learning model output device 300. The learning model output device 300 outputs the input learning model.

As described above, the learning model designation unit 160 designates a model having a parameter that minimizes the triplet loss function to which a value of the model when the triplet set of a group determined to satisfy the predetermined conditional expression is given is input.

The triplet set generation unit 110, the triplet set reduction unit 120, the data positional relationship learning unit 130, the conditional expression holding unit 140, the conditional expression satisfaction determination unit 150, and the learning model designation unit 160 are implemented by, for example, a central processing unit (CPU) of a computer (information processing device) that works in accordance with an adaptive data positional relationship learning program. In this case, the CPU can read the adaptive data positional relationship learning program from a program recording medium such as a program storage device of the computer, and work as the triplet set generation unit 110, the triplet set reduction unit 120, the data positional relationship learning unit 130, the conditional expression holding unit 140, the conditional expression satisfaction determination unit 150, and the learning model designation unit 160 in accordance with the read adaptive data positional relationship learning program.

### [Description of Working]

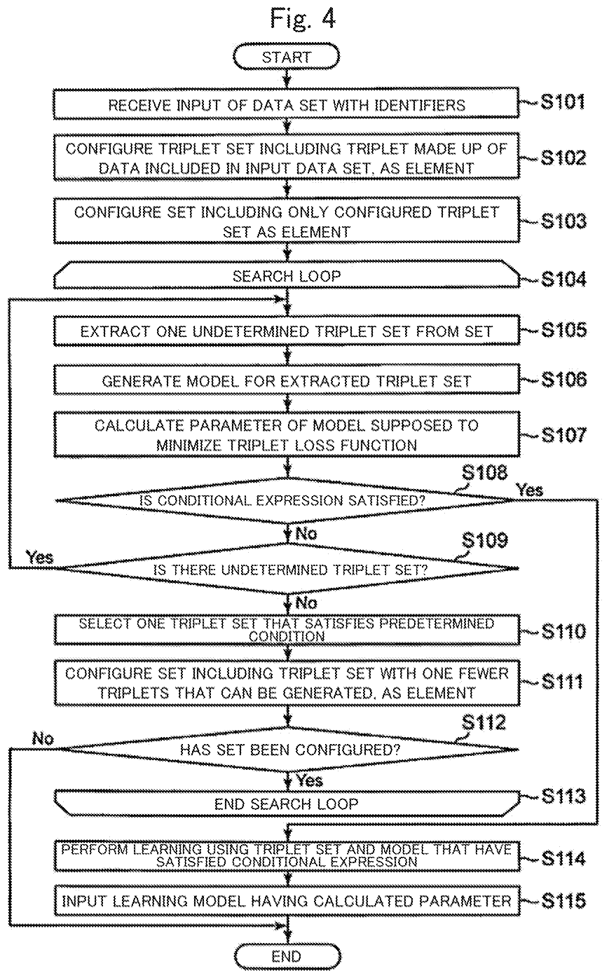

Hereinafter, the working of the adaptive learning device 100 of the present example embodiment will be described with reference to FIG. 4. FIG. 4 is a flowchart illustrating working of the data positional relationship learning process performed by the adaptive learning device 100 according to the present example embodiment.

The data positional relationship learning process illustrated in FIG. 4 is a process of learning the positional relationship between pieces of data on the basis of a data set assigned with identifiers. In the following description, the description will be omitted as appropriate for the matters already described.

First, a data set assigned with identifiers is input from the data input device 200 to the adaptive learning device 100 (step S101).

The triplet set generation unit 110 generates one or more triplets made up of anchor data and positive data to which the same identifier is assigned and negative data to which an identifier different from the identifier of the anchor data and positive data is assigned, on the basis of the input data set assigned with identifiers. The triplet set generation unit 110 then configures a triplet set including the generated triplet as an element (step S102).

Subsequently, the triplet set generation unit 110 configures a set including only the configured triplet set as an element (step S103). Thereafter, the triplet set generation unit 110 inputs the configured set to the data positional relationship learning unit 130. That is, a search loop is entered (step S104).

Following the above, the data positional relationship learning unit 130 extracts one undetermined triplet set from among multiple elements (triplet sets) of the input set (step S105).

The data positional relationship learning unit 130 then generates a model for the extracted triplet set (step S106). Subsequently, the data positional relationship learning unit 130 calculates a parameter of the model supposed to minimize the triplet loss function (step S107).

Thereafter, the data positional relationship learning unit 130 inputs the calculated model and the triplet set used for the calculation of the model to the conditional expression satisfaction determination unit 150. The conditional expression satisfaction determination unit 150 determines whether a group made up of the input model and triplet set satisfies the conditional expression (step S108).

The conditional expression used for the determination in step S108 may be a conditional expression generated by the conditional expression satisfaction determination unit 150 coupling a plurality of conditional expressions held in the conditional expression holding unit 140.

When the group made up of the model and the triplet set satisfy the conditional expression (Yes in step S108), the data positional relationship learning unit 130 inputs a set including only the triplet set satisfying the conditional expression as an element, to the learning model designation unit 160.

Following the above, the learning model designation unit 160 performs distance learning using the triplet set and the model that satisfy the conditional expression (step S114). That is, the learning model designation unit 160 calculates a parameter of the model, on the basis of the input triplet set.

The learning model designation unit 160 then inputs a learning model having the calculated parameter to the learning model output device 300 (step S115). After the input, the adaptive learning device 100 ends the data positional relationship learning process.

When the group made up of the model and the triplet set does not satisfy the conditional expression (No in step S108), the data positional relationship learning unit 130 determines whether the input set contains an undetermined triplet set (step S109).

When the input set contains an undetermined triplet set (Yes in step S109), the data positional relationship learning unit 130 performs the process in step S105 again.

When the input set contains no undetermined triplet set (No in step S109), the data positional relationship learning unit 130 inputs all groups made up of the models and the triplet sets determined in step S108, to the triplet set reduction unit 120.

Following the above, the triplet set reduction unit 120 selects one triplet set that meets a predetermined condition, from among the triplet sets of all the input groups (step S110).

The triplet set reduction unit 120 then generates a plurality of different triplet sets each having one fewer triplets than the triplet included in the selected triplet set as many as generatable. Specifically, the triplet set reduction unit 120 removes a subset from the selected triplet set. The subset may include one or more triplets.

Subsequently, the triplet set reduction unit 120 configures a set including the generated plurality of triplet sets as elements (step S111). Thereafter, the triplet set reduction unit 120 determines whether the set including the triplet sets as elements has been configured (step S112).

When the set has not been configured due to the reason that the triplet set is given as an empty set or the like (No in step S112), the adaptive data positional relationship learning device 100 exits the search loop (step S113) and ends the data positional relationship learning process.

When the set has been configured (Yes in step S112), the triplet set reduction unit 120 inputs the configured set to the data positional relationship learning unit 130. The data positional relationship learning unit 130 executes each processes in steps S105 to S112 again.

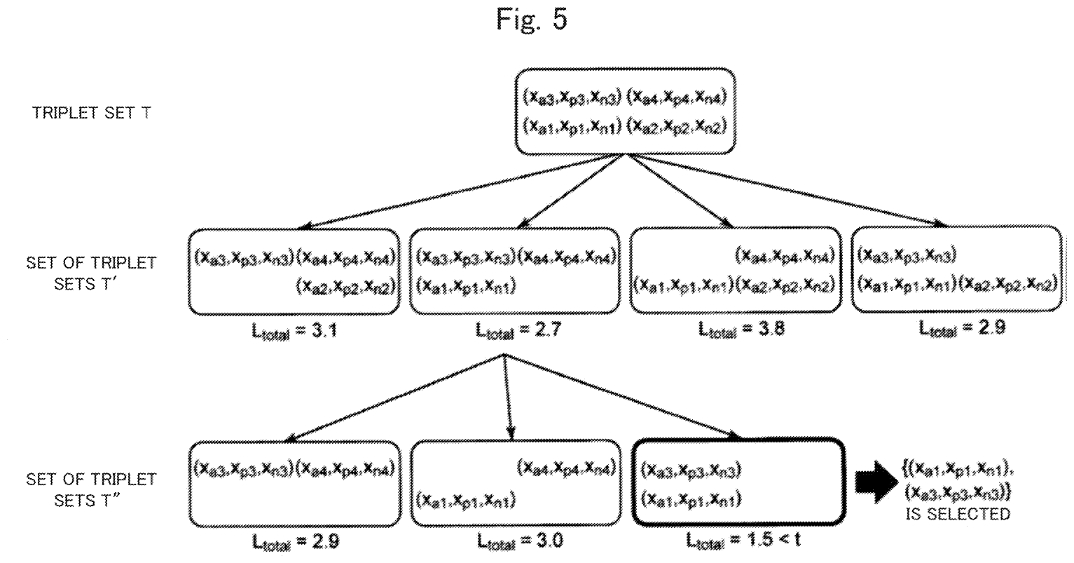

Next, a specific example of the data positional relationship learning process illustrated in FIG. 4 will be described with reference to FIG. 5. FIG. 5 is an explanatory diagram illustrating a specific example of the data positional relationship learning process.

In the example illustrated in FIG. 5, it is assumed that a set including only a triplet set T illustrated in FIG. 5 is first configured as a consequence of each processes in steps S101 to S103. It is also assumed that the triplet set T does not satisfy the conditional expression as a consequence of each processes in steps S105 to S108 (No in step S108).

Since the input set contains no undetermined triplet set (No in step S109), the data positional relationship learning unit 130 inputs groups made up of the models and the triplet sets T determined in step S108, to the triplet set reduction unit 120.

The triplet set reduction unit 120 then generates a plurality of different triplet sets T′ each having one fewer triplets than the triplet included in the triplet set T as many as generatable (steps S110 and S111). As illustrated in FIG. 5, the triplet set reduction unit 120 of this example generates four types of triplet sets T′.

Since the set including the triplet sets T′ as elements has been configured (Yes in step S112), the triplet set reduction unit 120 inputs the configured set to the data positional relationship learning unit 130. The data positional relationship learning unit 130 executes each processes in steps S105 to S112 again.

Lₜₒₜₐₗ illustrated in FIG. 5 denotes the minimum value of the total sum of the triplet loss functions obtained by using the parameters calculated in step S107. In step S108, the conditional expression satisfaction determination unit 150 of this example determines that the group made up of the model and the triplet set satisfies the conditional expression in a case where Lₜₒₜₐₗ is smaller than the threshold value t=2 specified in advance.

As illustrated in FIG. 5, Lₜₒₜₐₗ of all the four triplet sets T′ is equally greater than the threshold value t. Upon completion of the determination of the fourth triplet set T′ (No in step S109), the data positional relationship learning unit 130 inputs all groups made up of the models and the triplet sets T′ determined in step S108, to the triplet set reduction unit 120.

Following the above, the triplet set reduction unit 120 selects a triplet set T′ that meets the predetermined condition that the minimum value of the total sum of the triplet loss functions is the smallest, from among the triplet sets of all the input groups (step S110). In this example, the triplet set reduction unit 120 selects the second triplet set T′ from the left.

The triplet set reduction unit 120 then generates a plurality of different triplet sets T″ each having one fewer triplets than the triplet included in the selected triplet set T′ as many as generatable (step S111). As illustrated in FIG. 5, the triplet set reduction unit 120 of this example generates three types of triplet sets T″.

That is, the triplet set reduction unit 120 may generate a new triplet set on the basis of a triplet set of the group having a smallest value of the minimized triplet loss function among a plurality of the groups determined not to satisfy the predetermined conditional expression.

Since the set including the triplet sets T″ as elements has been configured (Yes in step S112), the triplet set reduction unit 120 inputs the configured set to the data positional relationship learning unit 130. The data positional relationship learning unit 130 executes each processes in steps S105 to S112 again.

As illustrated in FIG. 5, Lₜₒₜₐₗ of the third triplet set T″ from the left is “1.5” and is smaller than the threshold value t. Therefore, the data positional relationship learning unit 130 inputs, to the learning model designation unit 160, a set including only the third triplet set T″ from the left, which satisfies the conditional expression, as an element.

Following the above, the learning model designation unit 160 performs distance learning using the triplet set T″ and the model that satisfy the conditional expression (step S114). The learning model designation unit 160 then inputs a learning model having the calculated parameter to the learning model output device 300 (step S115), and ends the data positional relationship learning process.

In the data positional relationship learning process illustrated in FIGS. 4 and 5, all the triplet sets that have been generated are thoroughly searched, but not all the triplet sets are necessarily searched. For example, only triplet sets having higher priority calculated in accordance with a predetermined criterion may be searched.

### Description of Effects

The triplet set configuration method described in the above-mentioned “Facenet: A unified embedding for face recognition and clustering” is a configuration method that depends on the source image data set from which the triplet set is generated.

For example, in step 1, six pieces of image data are selected as anchor data for each identifier. However, if an enormous number of pieces of image data have the same identifier, it is likely to be difficult to perform highly accurate distance learning only by selecting six pieces of image data as anchor data.

The size of a data set collected without complying with any predetermined condition and the type of data belonging to the data set are generally uncertain. By contrast with the fact that the source data set from which the triplet set is generated is likely to have uncertainty, the configuration method described in “Facenet: A unified embedding for face recognition and clustering” is a fixed selection method for the triplet set. The cause of the difficulty in performing highly accurate distance learning is that a triplet set is configured by a fixed selection method using a data set that is likely to have uncertainty as a generation source.

In order to enhance the effect of distance learning, generally, it is important to properly select learning data (triplet set) that contribute to the accuracy of distance learning, from a given data set. The learning data obtained by the selection depends on the given data set.

Therefore, the process of selecting the learning data fixedly is not practical as a pre-process of distance learning when it is presumed that the given data set varies. A practical method of configuring a triplet set according to a source data set from which the triplet set is generated and learning a conversion rule using the configured triplet set has been required. JP 2019-083002 A does not describe a method of configuring a triplet set according to a source data set from which the triplet set is generated.

On the other hand, the adaptive learning device 100 of the present example embodiment can execute distance learning using a triplet set generated according to the generation source data set. The reason of this is that when there is no triplet set that satisfies a conditional expression imposed on the learning data, the triplet set reduction unit 120 adjusts the number of elements of the triplet set stepwise.

Then, for the triplet set whose number of elements has been adjusted, the data positional relationship learning unit 130 and the conditional expression satisfaction determination unit 150 execute the distance learning and the determination process again, respectively, and accordingly the triplet set as the learning data is more reliably searched.

Accordingly, the adaptive learning device 100 of the present example embodiment can configure a triplet set on the basis of a given data set, and learn the positional relationship between given pieces of data using the configured triplet set.

### Example

Hereinafter, an example in which the adaptive learning device 100 of the present example embodiment is applied to a vertex set constituting a graph structure will be described.

First, various parameters set when the adaptive learning device 100 executes the data positional relationship learning process in the present example will be described.

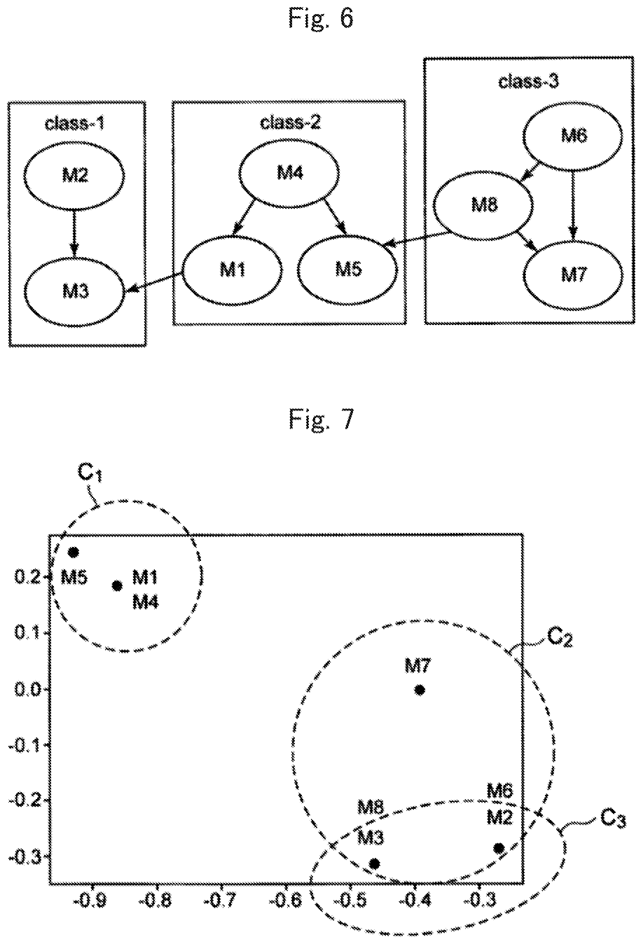

FIG. 6 is an explanatory diagram illustrating a graph targeted by the data positional relationship learning process according to the present example. The ellipses illustrated in FIG. 6 each represent a vertex of the graph. The letters in the ellipse denote the name of the relevant vertex.

The arrows connecting between the ellipses illustrated in FIG. 6 represent sides of the graph.

The letters in each rectangle illustrated in FIG. 6 denote an identifier assigned to a vertex represented by the ellipse in the rectangle. For example, an ellipse representing the vertex M2 is present in a rectangle in which “class-1” is written. Therefore, the vertex M2 is assigned with the identifier class-1.

The triplet set generation unit 110 generates a triplet on the basis of the vertex set {M1, M2, M3, . . . , M8} of the graph illustrated in FIG. 6. In the data positional relationship learning process of the present example, the triplet set generation unit 110 was set to derive a triplet set made up of all possible triplets for a plurality of pieces of data constituting a data set with identifiers.

Specifically, the triplet set generation unit 110 generates triplets by taking all possible combinations for each anchor data xₐ, and uses a set of all the generated triplets as an initial state S. For example,
in the case of xₐ=M1,

xₚϵ{M4,M5}=Pₓₐ,xₙϵ{M2,M3,M6,M7,M8}=Nₓₐ are used,
in the case of xₐ=M2,

xₚϵ{M3}=Pₓₐ,xₙϵ{M1,M4,M5,M6,M7,M8}=Nₓₐ are used

when the triplet set generation unit 110 generates a triplet set. That is, the initial state S given to the search process for designating the triplet set for learning is given by the following expression.

$$[ Mathematical Expression 6 ]$$

$$S = {⋃}_{{x}_{a} = M 1}^{M 8} \{ {x}_{a} \} \times {P}_{{x}_{a}} \times {N}_{{x}_{a}}$$

The subset used by the triplet set reduction unit 120 was set as a set made up only of the elements of the triplet set to be input.

Therefore, the number of types of triplet sets generated by the triplet set reduction unit 120 is equal to the number of elements of the triplet set to be input. Each triplet set to be generated is a set in which one triplet is removed from the triplet set to be input.

The constant α in the triplet loss function used by the data positional relationship learning unit 130 was set to “1”.

It was assumed that the conditional expression held in the conditional expression holding unit 140 is only expression (3). The threshold value t appearing on the right side of expression (3) was set to “3”, which is a real value.

The logical operation for the conditional expression executed by the conditional expression satisfaction determination unit 150 was set as a process of finding the logical AND of all the conditional expressions held in the conditional expression holding unit 140.

The learning models f_{θ} used in the overall data positional relationship learning process of the present example were all defined by a five-layer graph neural network. The output dimension of each vertex was set to “2”, which denotes an integer dimension. That is, each of the learned vertices is displayed on a plane.

FIG. 7 is an explanatory diagram illustrating the execution results of the data positional relationship learning process according to the present example. FIG. 7 illustrates the execution results plotted in a two-dimensional Euclidean space.

The two points in the dashed circle C₁ illustrated in FIG. 7 are points that constitute the graph illustrated in FIG. 6 and are related to the vertices M1, M4 and M5 belonging to class-2. The three points in the dashed circle C₂ illustrated in FIG. 7 are points that constitute the graph illustrated in FIG. 6 and are related to the vertices M6, M7 and M8 belonging to class-3.

The two points in the dashed circle C₃ illustrated in FIG. 7 are points that constitute the graph illustrated in FIG. 6 and are related to the vertices M2 and M3 belonging to class-1. Referring to FIG. 7, the learned vertices belonging to the same class are arranged closer to each other.

The two points in the circle C₁ are displayed at positions away from the three points in the circle C₂ and the two points in the circle C₃. Two of the three points in the circle C₂ and the two points in the circle C₃ are displayed superimposed in FIG. 7. However, when the execution results are plotted in a three-dimensional Euclidean space, it was confirmed that the three points in the circle C₂ are displayed at positions away from the two points in the circle C₃. That is, the vertices belonging to different classes are arranged farther from each other.

As a result of the execution of the data positional relationship learning process of the present example described above, it was confirmed that distance learning was performed in such a way that vertices belonging to the same class come closer to each other and vertices belonging to different classes go farther from each other.

The adaptive learning device 100 of the present example embodiment can be applied to a part of the authentication technology. Specifically, when an image data set assigned with identifiers is a data set to be input and a neural network model is used as the model, the adaptive learning device 100 is applied to the field of authentication technology.

The adaptive learning device 100 of the present example embodiment can also be applied to fields such as a social graph represented by a graph structure and an information technology (IT) system.

When applied to the field of social graphs, the adaptive learning device 100 of the present example embodiment can execute community estimation, product recommendation, and the like. When applied to the field of IT systems, the adaptive learning device 100 of the present example embodiment can execute refactoring work, performance estimation, and the like for modules constituting the system.

Specifically, when a set of groups of vertex attributes and attribute categories or groups of side attributes and attribute categories is used as a data set to be input, and a graph neural network is used as the model, the adaptive learning device 100 is applied to the field of community estimation. Alternatively, the adaptive learning device 100 is applied to the field of product recommendation, and to the field of refactoring work or the field of performance estimation for the modules constituting the system.

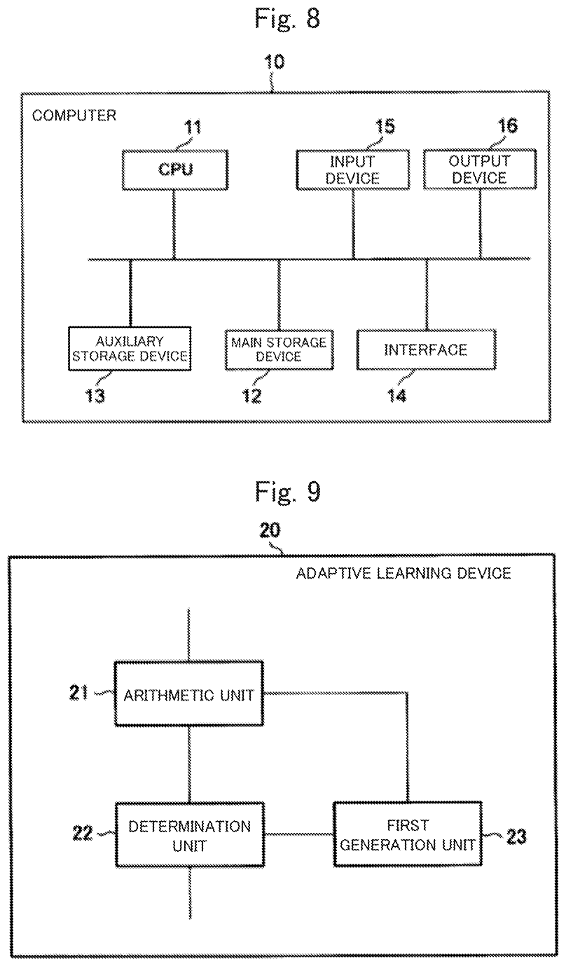

FIG. 8 is a schematic block diagram illustrating a configuration example of a computer on which the adaptive learning device 100 of the present example embodiment is mounted. The computer 10 illustrated in FIG. 8 includes a CPU 11, a main storage device 12, an auxiliary storage device 13, an interface 14, an input device 15, and an output device 16.

The adaptive learning device 100 of the present example embodiment is mounted on the computer 10. The adaptive learning program of data positional relationship that implements the working of the adaptive learning device 100 is stored in the auxiliary storage device 13.

The CPU 11 reads out the adaptive learning program of data positional relationship from the auxiliary storage device 13 to expand the read-out adaptive learning program of data positional relationship to the main storage device 12, and executes the processes described in the above example embodiment in accordance with the expanded adaptive learning program of data positional relationship. The main storage device 12 is, for example, a random access memory (RAM).

The auxiliary storage device 13 is, for example, a tangible medium that is not transitory. Non-transitory tangible media include a magnetic disk, a magneto-optical disk, a compact disc read only memory (CD-ROM), a digital versatile disk read only memory (DVD-ROM), a semiconductor memory, and the like connected via the interface 14.

The input device 15 has a function of inputting data and processing instructions. The input device 15 is, for example, a keyboard or a mouse.

The output device 16 has a function of outputting data. The output device 16 is, for example, a display device such as a liquid crystal display device or a printing device such as a printer.

When the adaptive learning program of data positional relationship is distributed to the computer 10 via a communication line, the computer 10 may expand the distributed program to the main storage device 12 and execute the above-described processes.

Some or all of multiple components may be implemented by general or dedicated circuitry, a processor, or a combination thereof. These components may be constituted by a single chip or a plurality of chips connected via a bus.

Some or all of multiple components may be implemented by a combination of the circuitry or the like described above and a program.

In a case where some or all of multiple components are implemented by a plurality of information processing devices, pieces of circuitry, or the like, the plurality of information processing devices, pieces of circuitry, or the like may be centrally arranged or dispersedly arranged. For example, the information processing devices, pieces of circuitry, or the like may be implemented as a form in which individual devices or pieces of circuitry or the like are connected via a communication network, such as a client and server system or a cloud computing system.

Next, an outline of the present invention will be described. FIG. 9 is a block diagram illustrating an outline of the adaptive learning device of data positional relationship according to the present invention. An adaptive learning device 20 of data positional relationship according to the present invention includes: an arithmetic unit 21 (for example, the data positional relationship learning unit 130) that calculates a parameter of a model having a mapping function of plotting a plurality of pieces of data in a Euclidean space, the parameter minimizing a triplet loss function to which a value of the model when a triplet set is given to the model is input; a determination unit 22 (for example, the conditional expression satisfaction determination unit 150) that determines whether a group made up of the model having the calculated parameter and the triplet set satisfies a predetermined conditional expression; and a first generation unit 23 (for example, the triplet set reduction unit 120) that generates a new triplet set to be targeted for an arithmetic operation by the arithmetic unit 21, by removing at least one triplet from the triplet set of the group determined not to satisfy the predetermined conditional expression.

With such a configuration, the adaptive data positional relationship learning device can learn the positional relationship between pieces of data even when any data set is given.

The adaptive learning device 20 may also include a designation unit (for example, the learning model designation unit 160) that designates a model having a parameter that minimizes the triplet loss function to which a value of the model when the triplet set of a group determined to satisfy the predetermined conditional expression is given is input.

With such a configuration, the adaptive data positional relationship learning device can output a learning model having the calculated parameter.

The adaptive learning device 20 may also include a second generation unit (for example, the triplet set generation unit 110) that generates a triplet set targeted for the arithmetic operation, on the basis of a data set made up of a plurality of pieces of data, to each of which an identifier is assigned, where a positional relationship between the plurality of pieces of data of the data set are targeted for learning.

The second generation unit may generate all triplets that are generatable, on the basis of the data set, and generate the triplet set made up of all the generated triplets.

With such a configuration, the adaptive learning device of data positional relationship can generate a triplet set according to data set assigned with identifiers, and can learn the positional relationship between the pieces of data on the basis of the generated triplet set.

The first generation unit 23 may generate a new triplet set on the basis of a triplet set of the group having a smallest value of the minimized triplet loss function among a plurality of the groups determined not to satisfy the predetermined conditional expression.

With such a configuration, the adaptive learning device of data positional relationship can shorten the time required for searching for a triplet set for learning.

The adaptive learning device 20 may include a holding unit (for example, the conditional expression holding unit 140) that holds a plurality of expressions used for generating the predetermined conditional expression, and the determination unit 22 may generate the predetermined conditional expression, on the basis of the plurality of expressions by logical operation. The plurality of expressions may include an expression relating to at least either the triplet set or the model.

With such a configuration, the adaptive learning device of data positional relationship can generate conditional expressions according to diverse requirements.

The model may be a neural network model or a graph neural network model.

With such a configuration, the adaptive learning device of data positional relationship is applied to the field of authentication technology.

1. An adaptive learning device of data positional relationship comprising:
at least one memory storing a computer program; and
at least one processor configured to execute the computer program to:
calculate a parameter of a model having a mapping function of plotting a plurality of pieces of data in a Euclidean space, the parameter minimizing a triplet loss function to which a value of the model is input when a triplet set is given to the model;
determine whether a group made up of the model having the parameter being calculated and the triplet set satisfies a predetermined conditional expression; and
generate a new triplet set to be targeted for an arithmetic operation, by removing at least one triplet from the triplet set of the group determined not to satisfy the predetermined conditional expression.

2. The adaptive learning device of data positional relationship according to claim 1, wherein the processor is configured to execute the computer program to
designate the model having the parameter that minimizes the triplet loss function to which the value of the model is input when the triplet set of the group determined to satisfy the predetermined conditional expression is given.

3. The adaptive learning device of data positional relationship according to claim 1, wherein the processor is configured to execute the computer program to
generate the triplet set to be targeted for the arithmetic operation, based on a data set made up of a plurality of pieces of data, to each of which an identifier is assigned, a positional relationship between the plurality of pieces of data of the data set being targeted for learning.

4. The adaptive learning device of data positional relationship according to claim 3, wherein the processor is configured to execute the computer program to
generate all triplets that are generatable, based on the data set; and
generate the triplet set made up of all the triplets being generated.

5. The adaptive learning device of data positional relationship according to claim 1, wherein the processor is configured to execute the computer program to
generate the new triplet set, based on the triplet set of the group having a smallest value of the minimized triplet loss function among a plurality of the groups determined not to satisfy the predetermined conditional expression.

6. The adaptive learning device of data positional relationship according to claim 1, wherein the processor is configured to execute the computer program to
hold a plurality of expressions used for generating the predetermined conditional expression;
generate the predetermined conditional expression, based on the plurality of expressions by logical operation.

7. The adaptive learning device of data positional relationship according to claim 6, wherein
the plurality of expressions include an expression relating to at least either the triplet set or the model.

8. The adaptive data positional relationship learning device according to claim 1, wherein
the model is a neural network model or a graph neural network model.

9. An adaptive learning method of data positional relationship performed by an information processing device,
the adaptive data positional relationship learning method comprising:
calculating a parameter of a model having a mapping function of plotting a plurality of pieces of data in a Euclidean space, the parameter minimizing a triplet loss function to which a value of the model is input when a triplet set is given to the model;
determining whether a group made up of the model having the parameter being calculated and the triplet set satisfies a predetermined conditional expression; and
generating a new triplet set to be targeted for an arithmetic operation, by removing at least one triplet from the triplet set of the group determined not to satisfy the predetermined conditional expression.

10. A computer-readable non-volatile recording medium storing an adaptive learning program of data positional relationship
for causing a computer to execute:
an arithmetic process of calculating a parameter of a model having a mapping function of plotting a plurality of pieces of data in a Euclidean space, the parameter minimizing a triplet loss function to which a value of the model is input when a triplet set is given to the model;
a determination process of determining whether a group made up of the model having the parameter being calculated and the triplet set satisfies a predetermined conditional expression; and
a generation process of generating a new triplet set to be targeted for the arithmetic process, by removing at least one triplet from the triplet set of the group determined not to satisfy the predetermined conditional expression.
